(19) United States
(12) Patent Application Publication
(10) Pub. No.: US 2024/0237636 A1
(43) Pub. Date: Jul. 18, 2024

(54) IMPROVED ADDITIVE SOLUTION FOR WHOLE BLOOD PRESERVATION AND STORAGE

(71) Applicant: University Of Cincinnati, Cincinnati, OH (US)

(72) Inventors: Jose Cancelas, Cincinnati, OH (US); Majid Zia, St. Paul, MN (US); John R. Hess, Seattle, WA (US)

(21) Appl. No.: 18/553,997

(22) PCT Filed: Apr. 7, 2022
(86) PCT No.: PCT/US2022/023873

§ 371 Date: Oct. 5, 2023

Related U.S. Application Data
(60) Provisional application No. 63/172,039, filed on Apr. 7, 2021.

(51) Int. Cl. A01N 1/02

(52) U.S. Cl. CPC A01N 1/0226; A01N 1/0242

(57) ABSTRACT

A whole blood anticoagulant composition and system including the composition, wherein the composition includes sodium bicarbonate, mannitol, sodium acetate, and magnesium citrate—and may optionally include sodium bisphosphate and/or adenine. The whole blood storage system may include apparatus that allows for whole blood leukoreduction with pH optimization for improved RBC storage. Such a system can provide leukoreduced whole blood for field medical use, and preserve RBCs and maintain or mostly maintain coagulation activity of the whole blood.

### RELATED APPLICATIONS

This application is an International PCT application claiming priority to U.S. Provisional Patent Application No. 63/172,039, filed Apr. 7, 2021, the entirety of which is incorporated by reference herein.

### FIELD OF THE INVENTION

Various aspects of the present invention relate to the storage of blood and blood products, and to a system for the collection, processing, and storage of blood and blood products.

### BACKGROUND OF THE INVENTION

This section is intended to introduce the reader to various aspects of art that may be related to various aspects of the present invention, which are described and/or claimed below. This discussion is believed to be helpful in providing the reader with background information to facilitate a better understanding of various aspects of the present invention. Accordingly, it should be understood that these statements are to be read in this light, and not as admissions of prior art.

Hemorrhage is the leading cause of preventable death in both military and civilian traumatic injury. And so, there is ongoing interest in optimizing transfusion practice during massive hemorrhage resuscitation. For various reasons, the military has adopted the practice of whole blood (WB) transfusion in certain situations (e.g., combat casualties with severe blood loss)—as opposed to the transfusion of individual blood components (i.e., individual blood component therapy—“CT”). Given the successful use of whole blood in the military, civilian hospitals have adopted massive transfusion protocols that simulate whole blood transfusion, by administering plasma, platelets (PLTs), and red blood cells (RBCs) in equal ratios.

For patients with life threatening hemorrhage, resuscitation with blood products is essential in addition to hemorrhage control. Whole blood transfusions have a long history in military medicine, beginning in World War I, when it was demonstrated that transfusion of uncross-matched whole blood decreased mortality in combat casualties with severe blood loss. In 2014, the U.S. Tactical Combat Casualty Care Committee recommended whole blood as the optimal product for the resuscitation of patients with traumatic hemorrhagic shock.

Whole blood has multiple advantages compared to individual blood component therapy (CT). Nessen et al. demonstrated that Type O whole blood was independently associated with improved outcomes when compared with RBCs and plasma alone at U.S. military forward surgical bases. The practice of ABO compatible transfusion with RBCs or whole blood carries an approximately 1:80,000 risk of fatal hemolytic reaction due to transfusion of ABO-incompatible RBCs, largely due to human error in matching donor and recipient appropriately. Low Titer O Whole Blood (LTOWB)—unseparated blood that is collected from a donor with “low” IgM and/or IgG anti-A and anti-B—can be used without waiting for crossmatch results, thereby reducing the time to transfusion, and potentially improving survival. Studies have shown that time is of the essence and minutes matter when it comes to transfusing the hemorrhaging combat casualty. LTOWB also has the advantage of being the most logistically feasible option in the far forward environment; it only requires refrigeration compared to a balanced component transfusion strategy that not only requires refrigeration, but a freezer, incubator, and thawer as well.

For the aforementioned reasons, there has been a huge impetus to push LTOWB far forward in the combat environment. Early in the conflict in Iraq, walking blood banks were used to collect warm fresh whole blood (WFWB) when the full complement of blood components was not available. Although not FDA approvable (due to the austere collection processes and lack of qualified donor screening), over 10,000 units of WFWB have been transfused in Iraq and Afghanistan as part of well-trained Walking Blood Banks on forward operating bases.

The use of cold stored low titer O whole blood (CS-LTOWB) has been steadily increasing in US civilian hospitals. In the past 5 years, whole blood has increasingly been recognized by civilian hospitals as being simpler to administer and potentially more effective than component transfusion for trauma resuscitation. The major barriers to wider adoption of whole blood include medical and (until 2018) regulatory concerns associated with transfusion of group O whole blood to non-group O patients. Recently, the use of LTOWB has gained traction, particularly after changes to AABB (American Association of Blood Banks) standards in 2018. Most recently, in some metropolitan areas, civilian emergency services have adapted CS-LTOWB into their ground and air ambulances. National summits are being held to study the implementation of CS-LTOWB and lessons learned from shared experiences (e.g., at the 1st Annual National Whole Blood Summit, San Antonio, TX, in May 2019).

Previous studies have evaluated the hemostatic effects of non-leukoreduced (non-LR) cold-stored whole blood at various points in storage and have generally concluded that many coagulation factors (other than the labile Factor [F]VIII) are preserved at 1 to 6° C. for 14 days or more. In most of the United States, leukoreduction (i.e., the removal of white blood cells from the blood or blood components supplied for blood transfusion) is a strongly preferred modification for all applicable components. Although there is not a strong scientific or clinical mandate to leukoreduce blood that is destined for trauma patients, the relevance of leukoreduction to the trauma patient is highlighted by the revelation that at least one institutional review board (IRB) required the use leukoreduced whole blood, rather than non-leukoreduced whole blood, in a trial of civilian trauma patients. Historically, whole blood has not been leukoreduced before transfusion, and the current medical literature is only beginning to evaluate the effects of leukoreduction on the functionality of whole blood. Leukoreduction has long been shown to have important benefits for patients, including low rates of alloimmunization, febrile transfusion reactions, and reduced cytomegalovirus transmission. And so, many hospitals are likely to consider a leukoreduced formulation when introducing whole blood into their inventories. Furthermore, pre-storage leukoreduction is generally seen as a standard of care such that practicality favors the use of leukoreduced whole blood, because units of whole blood that are not transfused can be manufactured into pre-storage leukoreduced-RBCs by qualified blood banks.

Since 2015, the Armed Service Blood Program (ASBP) has supported the 75th Ranger Regiment with LTOWB in support of operational missions worldwide. The LTOWB Program was subsequently expanded to other SOCOM (U.S. Special Operations Command) units. With ASBP tasking of additional whole blood units, the military blood collection centers have been constrained to meet current and new operational whole blood requirements using currently available licensed blood collection bags, with a limited shelf life of 35 days in Citrate-Phosphate-Dextrose solution with Adenine (CPDA-1)—an anticoagulant solution used for the preservation of whole blood and RBCs, and extension of RBC survival by providing adenine needed for the maintenance of RBC ATP levels. A 35-day shelf-life collection bag only actually provides three to four weeks of operational time before the unit of blood expires. The shelf life of whole blood challenges the logistical ability to meet everyday missions where “each day counts.” Worldwide movement of whole blood missions require special air transportation due to time lost at refueling points. Requests to support Conventional Forces exceed the current capability of the ASBP in large part by the short shelf life of 35 days for whole blood collected in CPDA-1 (a standard anticoagulant solution used in blood storage and preservation). The logistical burden to support operational missions is extremely taxing for military blood banks and leads to large expirations of a precious resource if not transfused. Future military operations involving greater distances from the continental United States (CONUS) support bases, lack of air superiority, and peer to peer conflict will enhance the logistical challenges in meeting the blood support availability.

A blood collection system with an increased shelf life (e.g., double or triple the current shelf life) for collected whole blood units would mitigate the risk to the blood supply logistics system. However, blood bag anticoagulation-preservative solutions have not changed in over 40 years. With the advent of blood component therapy in the late 1960's, the use of whole blood had diminished. The U.S. Military in recent years has been on the forefront in rediscovering the benefits of whole blood transfusions. Blood collection bags innovations in recent years have focused on improvements in additive solutions to improve the storage lesion of packed RBCs. Given the many logistical benefits of CS-LTOWB in the prehospital and austere Role 2 environments (providing a full spectrum of component therapy in one product, with no need for freezers/thawers), there is a significant demand signal for CS-LTOWB in U.S. Central Command (CENTCOM). CS-LTOWB has been embraced for damage control resuscitation since its resurgence into the combat theaters in 2016, proving its feasibility in the austere environment. The clinical benefits of CS-LTOWB, such as better oxygen carrying capacity and hemostatic function compared to a balanced resuscitation of RBC, FFP, and platelets are the likely reason for the large demand signal and the relatively high utilization ratio. CS-LTOWB not only simplifies the resuscitative effort by not requiring thawing or cross-matching, but it also is space-efficient and shortens time to transfusion, which may contribute to improved survival.

To date, many methods have been described and used for blood collection, processing and storage for transfusion. And multiple storage solutions have been developed. In addition to CPDA-1 (described above), CPDA-2 is a storage solution developed by the U.S. Army (see Sohmer P R, Moore G L, Beutler E, Peck C C., In vivo viability of red blood cells stored in CPDA-2, Transfusion. 1982 November-December; 22(6): pp. 479-484)—and was developed to provide a solution that could improve RBC survival rates over that seen with CPDA-1. CPDA-2 was developed and tested with human blood, and worked well, but was never licensed or sold.

As described above, leukoreduction of any whole blood that is collected and stored is also desirable (and may be strongly preferred in some cases). A variety of whole blood leukoreduction (LR) filters exist, and many are FDA licensed for sale in the United States. First generation whole blood and red blood cell leukoreduction filters were primarily developed for reducing leukocytes in whole blood or red blood cell products. However, these first generation filters not only reduced leukocytes but also reduced platelet content of blood and blood products. The next generation of leukoreduction filters enable the leukoreduction of whole blood while substantially sparing platelets and providing a system for preparation of four important leukoreduced therapeutic products: Red Blood Cells (RBC), Platelet Rich Plasma (PRP), Platelet Poor Plasma (PPP), and Platelets. An example of such a system is IMUFLEX® WB-SP by Terumo Corporation.

The IMUFLEX® system uses a typical anticoagulant, CPD (a citrate-phosphate-dextrose solution), in the collection of whole blood, and uses a platelet sparing leukoreduction filter to produce a leukocyte-reduced whole blood component. The filtration system includes a bypass to substantially drain the entire collected whole blood component through the filter and to prepare a substantially air free leukoreduced CPD whole blood component. The platelet rich whole blood component may be further separated into blood components including red blood cells in an additive solution.

Blood storage systems are typically acidic (e.g., at a pH of about 5.5) to prevent the dextrose they contain from caramelizing when they are autoclaved to sterilize them. Adding extra alkaline constituents to raise the pH improves metabolism. Bicarbonate is particularly useful in this regard because it is nontoxic, breaking down into water and CO₂ and a buffer. The process of adding sodium bicarbonate to blood storage systems to raise the pH closer to, but less than, 7.2 and to buffer the acid produced by glycolysis was developed by Hess & Greenwalt and is the subject of multiple patents (including U.S. Pat. Nos. 6,150,085, 6,447,987, 8,709,707, 9,314,014, 6,150,085, 6,447,987, 8,709,707, and 9,314,014—the disclosures of which are hereby incorporated by reference herein in their entireties).

However, the need for a blood collection system with an increased shelf life remains.

### SUMMARY OF THE INVENTION

Certain exemplary aspects of the invention are set forth below. It should be understood that these aspects are presented merely to provide the reader with a brief summary of certain forms the invention might take and that these aspects are not intended to limit the scope of the invention. Indeed, the invention may encompass a variety of aspects that may not be explicitly set forth below.

Aspects of the present invention overcome and/or reduce the drawbacks described above by providing a whole blood anticoagulant composition, whole blood storage system, and method for use of same.

One aspect of the invention, then, is directed to a whole blood anticoagulant composition including one or more sodium salts, one or more magnesium salts, and one or more sugar alcohols. In various embodiments, the composition the one or more sodium salts include sodium bicarbonate and sodium acetate, the one or more magnesium salts include magnesium citrate, and the one or more sugar alcohols include mannitol. Additionally, the composition may include sodium bisphosphate. Further, the composition may include at least one nucleobase-containing component, such as adenine. And it may include one or more sugars, such as dextrose or glucose.

Another aspect of the present invention is directed to a whole blood anticoagulant composition including sodium bicarbonate (NaHCO₃), mannitol (C₆H₁₄O₆), sodium acetate (C₂H₃NaO₂), and magnesium citrate (C₆H₆MgO₇). In additional embodiments, that composition may also include sodium bisphosphate (Na₂HPO₄). In still further embodiments, adenine (C₅H₅N₅) may be added to the composition. Another aspect of the present invention is directed to a whole blood anticoagulant composition comprising a first substance and a second substance, wherein the first substance includes a plurality of components, the plurality of components including sodium bicarbonate (NaHCO₃), mannitol (C₆H₁₄O₆), sodium acetate (C₂H₃NaO₂), and magnesium citrate. In additional embodiments, that first substance may also include sodium bisphosphate (Na₂HPO₄). In still further embodiments, adenine (C₅H₅N₅) may be added to the first substance.

Other aspects of the present invention are directed to whole blood storage systems—and such storage systems may incorporate a whole blood anticoagulant composition—such as those described above (or described below in greater detail). And so, described herein, is a whole blood storage system that includes whole blood leukoreduction with pH optimization for improved RBC storage. The system includes a two-component anticoagulant system that not only enables sterilization of the contents without degradation but simplifying the design, components, operations, and overall cost of the collection and processing system.

Such a system can provide leukoreduced whole blood for field medical use by preserving the RBCs, plasma, platelets and in effect maintaining or mostly maintaining effective oxygen delivery and coagulation activity of the whole blood for an extended period of time, (e.g., about 5 weeks). This extended time for preservation of whole blood over current systems also allows for the subsequent preparation of components, such that precious blood units would not go to waste.

In one exemplary embodiment, a whole blood storage system may include a first additive and a second additive, where one of the additives (e.g., the first additive or the second additive) includes a bicarbonate ion-providing component such as sodium bicarbonate (NaHCO₃), a sugar alcohol such as mannitol (C₆H₁₄O₆), and a salt such as sodium acetate (C₂H₃NaO₂) and/or magnesium citrate (C₆H₆MgO₇). In additional embodiments, the additive may also include a phosphate ion providing component such as sodium bisphosphate (Na₂HPO₄). In still further embodiments, a nucleobase-containing component such as adenine (C₅H₅N₅) or guanosine may be added to the additive. In still further embodiments, an amino acid or derivative thereof such as carnitine or methionine guanosine may be added to the additive. In such a system, the first additive and second additive may be combined. And when combined, the coagulation capability of the whole blood may be maintained or mostly maintained for at least about 2 weeks or at least about 3 weeks or at least about 4 weeks. Additionally, or alternatively, when the first additive and the second additive are combined with whole blood, the whole blood can be preserved for at least about 2 weeks or at least about 3 weeks or at least about 4 weeks or at least about 5 weeks or at least about 6 weeks and red blood cells for at least about 2 weeks or at least about 3 weeks or at least about 4 weeks or at least about 5 weeks or at least about 6 weeks or at least about 7 weeks.

In another embodiment of the whole blood storage system, one of the additives (e.g., the first additive) can be CPD, CP2D, CPDA-1, or CPDA-2, and the other (e.g., second) additive can include at least sodium bicarbonate. In alternative embodiments, the first additive can include citric acid, sodium citrate, and/or dextrose and the second additive can include phosphate, bicarbonate and/or adenine. Other constituents and various separation of the constituents into first and second additive are possible to provide improved storage and therapeutic benefits. The system, in a non-limiting embodiment, includes first and second additive bags for holding the first and second additives, and at least the first additive bag is suitable for the storage of whole blood and/or blood plasma and/or red blood cells (RBC).

Another aspect of the present invention may be directed to a method of storing whole blood. This aspect may include adding whole blood to be collected into a first receptacle, the first receptacle containing a first additive, and transferring a second additive from a second receptacle to the first receptacle. The second additive may include sodium bicarbonate (NaHCO₃), mannitol (C₆H₁₄O₆), sodium acetate (C₂H₃NaO₂), and magnesium citrate (C₆H₆MgO₇). In additional embodiments, that second additive may also include sodium bisphosphate (Na₂HPO₄). In still further embodiments, adenine (C₅H₅N₅) may be added to the second additive. Additionally, the transferring step may occur before or after the step of adding whole blood into the first receptacle.

### BRIEF DESCRIPTION OF THE DRAWINGS

The accompanying drawings, which are incorporated in and constitute a part of this specification, illustrate embodiments of the invention and, together with the general description of the invention given above and the detailed description of the embodiments given below, serve to explain the principles of the present invention.

FIG. 1 is a chart showing a comparison of the expected shelf life availability of blood stored using a blood storage system in accordance with principles of the present invention versus currently used anticoagulant solutions.

FIG. 2 is a graph showing clotting properties that are maintained for >2 weeks of cold storage in a solution including a first additive and a second additive in accordance with principles of the present invention.

FIG. 3 is a graph showing red blood cell counts of blood stored in CPD and a solution in accordance with principles of the present invention before and after leukocyte reduction of whole blood units.

FIG. 4 is a graph showing morphological and functional characteristics of platelets (PLT) derived from whole blood units stored in a solution including a first additive and a second additive in accordance with principles of the present invention.

FIG. 5 is a schematic showing a whole blood preparation system in accordance with principles of the present invention.

FIG. 6 is an additional schematic showing a whole blood or blood component preparation system in accordance with principles of the present invention.

### DETAILED DESCRIPTION OF THE PREFERRED EMBODIMENTS

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

As described above, aspects of the present invention overcome and/or reduce the drawbacks described above by providing a whole blood anticoagulant composition, whole blood storage system, and method for use of same. One aspect of the invention, then, is directed to a whole blood anticoagulant composition including one or more sodium salts, one or more magnesium salts, and one or more sugar alcohols. In various embodiments, the composition the one or more sodium salts include sodium bicarbonate and sodium acetate, the one or more magnesium salts include magnesium citrate, and the one or more sugar alcohols include mannitol. Additionally, the composition may include sodium bisphosphate. Further, the composition may include at least one nucleobase-containing component, such as adenine. And it may include one or more sugars, such as dextrose or glucose.

Another aspect of the present invention is directed to a whole blood anticoagulant composition including sodium bicarbonate (NaHCO₃), mannitol (C₆H₁₄O₆), sodium acetate (C₂H₃NaO₂), and magnesium citrate (C₆H₆MgO₇). In additional embodiments, that composition may also include sodium bisphosphate (Na₂HPO₄). In still further embodiments, adenine (C₅H₅N₅) may be added to the composition. Another aspect of the present invention is directed to a whole blood anticoagulant composition comprising a first substance and a second substance, wherein the first substance includes a plurality of components, the plurality of components including sodium bicarbonate (NaHCO₃), mannitol (C₆H₁₄O₆), sodium acetate (C₂H₃NaO₂), and magnesium citrate. In additional embodiments, that first substance may also include sodium bisphosphate (Na₂HPO₄). In still further embodiments, adenine (C₅H₅N₅) may be added to the first substance. Herein, this novel whole blood anticoagulant composition may be referred to as “the APEX™ composition,” and systems including the composition may be referred to as “the APEX™ system.”

Other aspects of the present invention are directed to whole blood storage systems—and such storage systems may incorporate a whole blood anticoagulant composition—such as those described above (or described below in greater detail). And so, described herein, is a whole blood storage system that includes whole blood leukoreduction with pH optimization for improved RBC storage. The system includes a two-component anticoagulant system that not only enables sterilization of the contents without degradation but simplifying the design, components, operations, and overall cost of the collection and processing system.

Such a system can provide leukoreduced whole blood for field medical use by preserving the RBCs, plasma, platelets and in effect maintaining or mostly maintaining effective oxygen delivery and coagulation activity of the whole blood for an extended period of time, (e.g., at least about 5 weeks). This extended time for preservation of whole blood over current systems also allows for the subsequent preparation of components, such that precious blood units would not go to waste.

As used herein, by “preserve” is meant that the indicated cells meet the criteria for being preserved after being stored for the indicated time. The time will differ for the type of cell being stored. When the cells being stored are red blood cells (RBCs), the RBCs are said to be preserved for 6 weeks (i.e., 42 days) when the RBCs have a level of hemolysis below about 1.0% with 95% confidence that at least 95% of the population estimate will have less than 1% hemolysis after 42 days of storage. When the cells being stored are whole blood (WB), the WB is said to be preserved for 5 weeks (i.e., 35 days) based on red blood cell quality parameters, such red blood cell hemolysis level. For example, WB is said to be preserved for 5 weeks (i.e., 35 days) when the RBCs in the WB have a level of hemolysis below about 1.0% with 95% confidence that at least 95% of the population estimate will have less than 1% hemolysis after 35 days of storage.

As used herein, the coagulation capability of the whole blood is said to be maintained when the coagulation activity of the stored whole blood as described herein is at least about 75% as compared to the coagulation activity of conventionally collected whole blood on the same day or the day after collection as measured using standard clotting assays. Non-limiting clotting assays include thromboelastography (TEG), prothrombin time (PT), activated partial thromboplastin time (aPTT), and thrombin time (TT), Russell's viper venom time. The coagulation capability of the whole blood is said to be mostly maintained (i.e., “most coagulation activity”) when the coagulation activity of the stored whole blood as described herein is at least about 50% as compared to the coagulation activity of conventionally collected whole blood on the same day or the day after collection as measured using standard clotting assays. Non-limiting clotting assays include thromboelastography (TEG), prothrombin time (PT), activated partial thromboplastin time (aPTT), and thrombin time (TT), and Russell's viper venom time

In one exemplary embodiment, a whole blood storage system may include a first additive and a second additive, where one of the additives (e.g., the first additive) includes sodium bicarbonate (NaHCO₃), mannitol (C₆H₁₄O₆), sodium acetate (C₂H₃NaO₂), and magnesium citrate (C₆H₆MgO₇). In additional embodiments, that composition may also include sodium bisphosphate (Na₂HPO₄). In still further embodiments, adenine (C₅H₅N₅) may be added to the composition. In such a system, the first additive and second additive may be combined. And when combined, the coagulation capability of the whole blood may be maintained or mostly maintained for at least about 2 weeks or at least about 3 weeks or at least about 4 weeks. Additionally, or alternatively, when the first additive and the second additive are combined with whole blood, the whole blood can be preserved for at least about 2 weeks, or at least about 3 weeks, or at least about 4 weeks, or at least about 5 weeks or at least about 6 weeks and red blood cells for at least about 2 weeks, or at least about 3 weeks, or at least about 4 weeks, or at least about 5 weeks or at least about 6 weeks or at least about 7 weeks from the time of the combination.

In another embodiment of the whole blood storage system, one of the additives (e.g., the first additive) can be CPD, CP2D, CPDA-1, or CPDA-2, and the other (e.g., second) additive can include at least sodium bicarbonate. In alternative embodiments, the first additive can include citric acid, sodium citrate, and/or dextrose and the second additive can include phosphate, bicarbonate and/or adenine. Other constituents and various separation of the constituents into first and second additive are possible to provide improved storage and therapeutic benefits. The system, in a non-limiting embodiment, includes first and second additive receptacles for holding the first and second additives, and at least the first additive receptacle is suitable for the storage of whole blood and/or blood plasma and/or red blood cells (RBC).

In various non-limiting embodiments of the system described herein, neither the first additive nor the second additive alone will preserve whole blood for more than about 5 weeks or more than about 6 weeks.

Another aspect of the present invention may be directed to a method of storing whole blood. This aspect may include adding whole blood to be collected into a first receptacle, the first receptacle containing a first additive, and transferring a second additive from a second receptacle to the first receptacle. The second additive may include sodium bicarbonate (NaHCO₃), mannitol (C₆H₁₄O₆), sodium acetate (C₂H₃NaO₂), and magnesium citrate (C₆H₆MgO₇). In additional embodiments, that second additive may also include sodium bisphosphate (Na₂HPO₄). In still further embodiments, adenine (C₅H₅N₅) may be added to the second additive. Additionally, the transferring step may occur before or after the step of adding whole blood into the first receptacle.

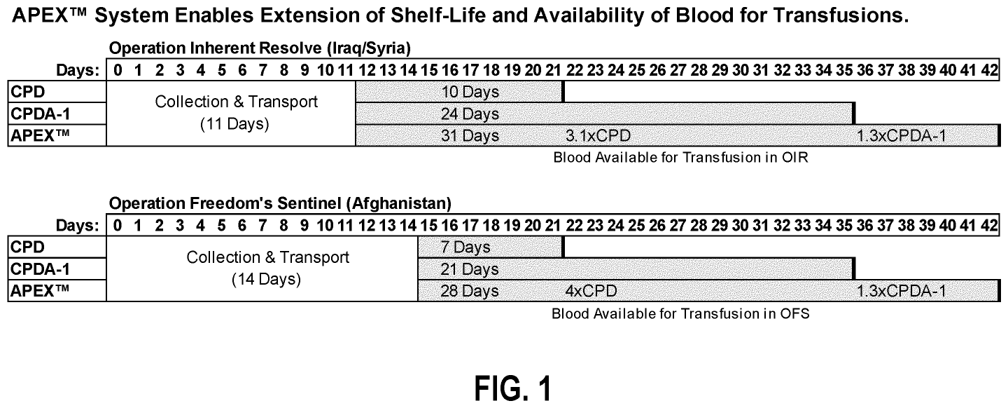

Thus, the present invention—in certain embodiments—includes a whole blood collection, processing, and storage system including a novel whole blood anticoagulant (“the APEX™ composition”)—the novel composition including sodium bicarbonate, sodium bisphosphate, mannitol, sodium acetate, and magnesium citrate (and optionally sodium bisphosphate and/or adenine). By doing so, the storage system of aspects of the present invention provides a superior anticoagulant-preservative solution for damage control interventions closer to the point of need than do current solutions, and thus can be used to optimize sustained resuscitation for hemorrhagic shock. The system of the present invention thus also provides a longer shelf life of whole blood products than what is currently in use. It also simplifies the logistics of providing whole blood, reduces the expiration rate, and maximizes the collection of precious blood donations while providing a cost savings in blood support. This can be seen with references to FIG. 1—which shows a comparison of the expected shelf life availability of blood stored using a blood storage system in accordance with principles of the present invention versus currently used anticoagulant solutions. As can be seen in FIG. 1, blood for transfusion in both operations shown (Inherent Resolve and Freedom's Sentinel) was available for a longer period of time (due to an extended preservation) due to the use of the system of the present invention (shown as APEX™ in FIG. 1), as compared to the use of storage solutions and systems using only conventional CPD or CPDA-1. In fact, as can be seen, the use of the APEX solution/system provided 21 extra days of use than CPD in both Operations. And, the use of the APEX solution/system provided 7 extra days of use than CPDA-1 in both Operations. Further, as can be seen from FIG. 1, transit time from CONUS to a Theater of Operations can consume up to two weeks of valuable shelf life (11 days in Inherent Resolve, and 14 days in Freedom's Sentinel). The increase in shelf life demonstrated by the APEX solution of the present invention would reduce operational cost, reduce the logistics support needed, reduce blood unit expirations, and increase the availability of blood for all conventional and unconventional forces.

The system is aligned with the FY 2021 (FY21) Defense Medical Research and Development Program Joint Program Committee 6 Combat Casualty Care Research Program Battlefield Resuscitation for Immediate Stabilization of Combat Casualties Award Program Focus Area on development of novel or engineered blood products that offers physiological, logistical or cost advantage over current products and able to treat combat-related and trauma-induced injuries in the pre-hospital setting. And, the APEX blood system provides a superior anticoagulant-preservative solution for damage control interventions closer to the point of need and thus can be used to optimize sustained resuscitation for hemorrhagic shock to support large scale Multi-Domain Operations (MDO) and high demand peak conflicts (as applied to a military environment). The system of the present invention thus improves the mission support with a longer shelf life of whole blood products than what is currently in use. It also simplifies the logistics of providing whole blood far forward than current products for SOCOM and conventional forces, reduces the expiration rate, and maximizes the collection of precious blood donations while providing a cost savings in blood support (as described above, with respect to FIG. 1).

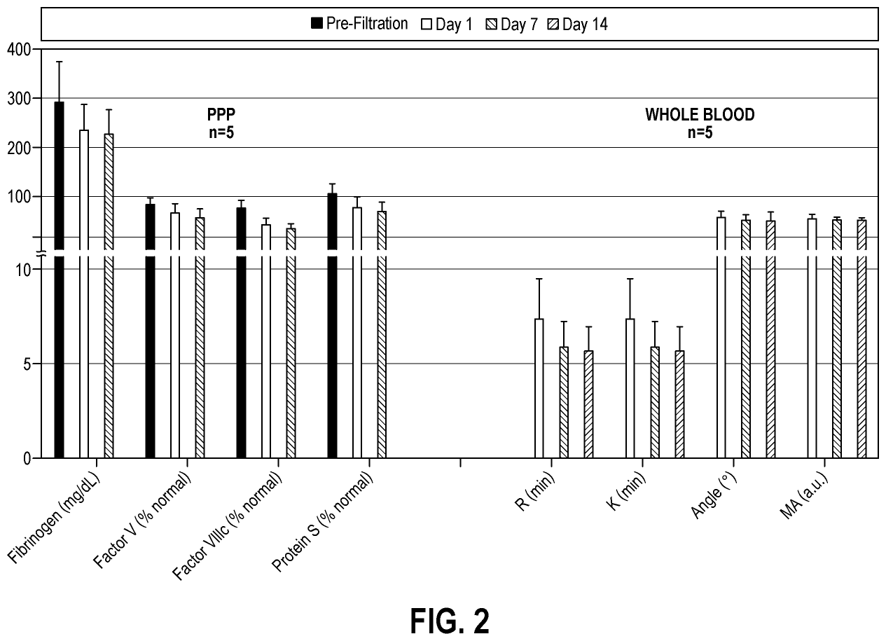

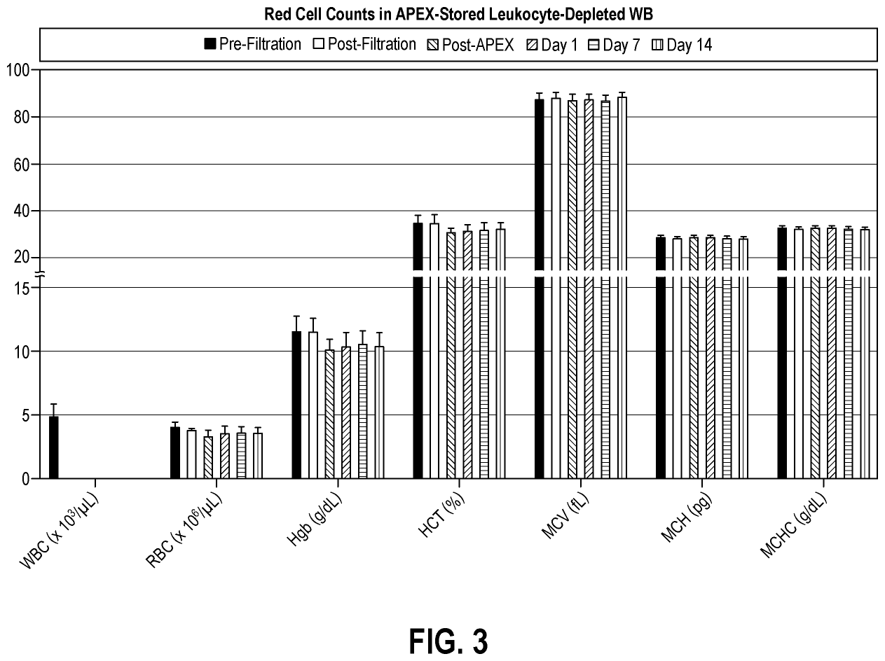

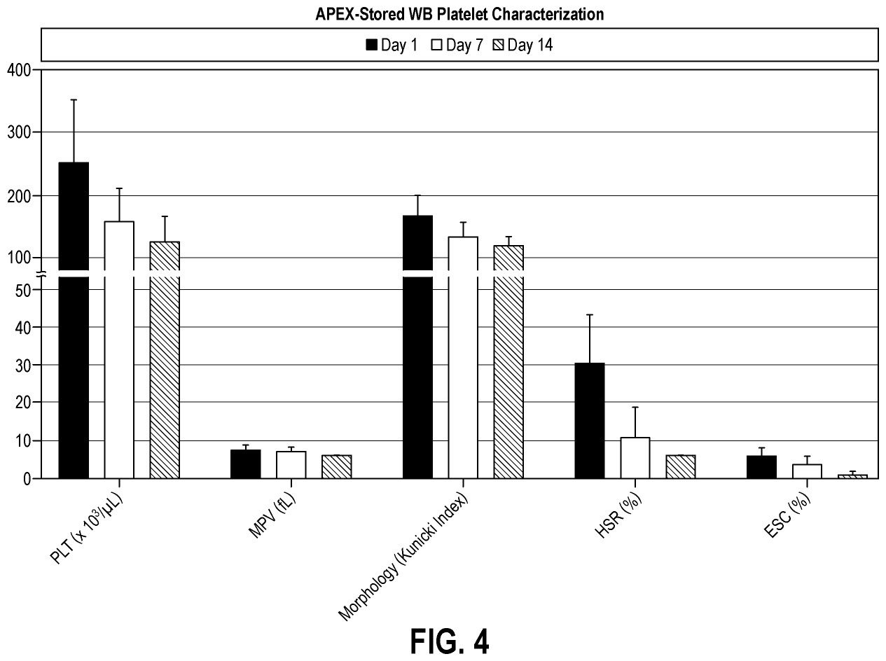

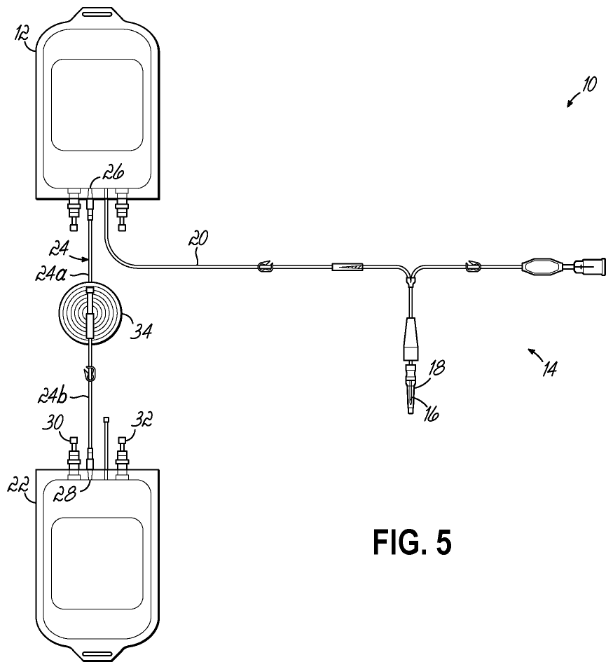

FIGS. 2-4 show that the novel composition of one aspect of the present invention improves shelf life. In these figures, one can see that studies utilizing cell quality factors by thromboelastography showed similar profiles for at least 14 days whether as whole blood (see FIGS. 2 and 5) or as blood components (see FIGS. 3 and 4). In particular, FIG. 2 is a graph showing clotting properties that are maintained for greater than 2 weeks of cold (e.g., storage at 1-6° C.) storage in a solution including a first additive (being CPD) and a second additive (being an APEX™ composition). More specifically, the graph in FIG. 2 shows whole blood clotting properties that are maintained for greater than 2 weeks of cold storage in additives of CPD and APEX™. Plasma clotting factor content (Fibrinogen, Factor V, Factor VIIIc, Protein S) in Platelet-Poor-Plasma (PPP) obtained from whole blood stored in CPD and APEX™ composition is shown on the left side of FIG. 2, (PPP, n=5 units, and CPD/APEX whole blood (n=5 units) thromboelastography data is shown on the right side of FIG. 2, (whole blood, n=5 units) before whole blood cell collection and filtration (black bars), 1 day after whole blood cell collection and filtration (white bars), 7 days after whole blood cell collection and filtration (diagonally striped rising to the left bars), and 14 days after whole blood cell collection and filtration (diagonally striped rising to the right bars).

FIG. 3 is a graph showing red blood cell counts of blood stored in a solution including CPD and APEX before and after leukocyte reduction of whole blood units. The graph in FIG. 3 shows red cell counts before (solid black bars) and after leukocyte depletion (clear bars), and after combination with the APEX formulation described herein (diagonally striped rising to the left bars) of CPD/APEX Whole Blood units (n=5). More specifically, FIG. 3 shows the counts of white blood cells (as 10³/ul; left-most section), red blood cells (as 10⁶/ul; second from left section), hemoglobin (Hgb) amounts in g/dL; third from left section), hematocrit (HCT) as a percentage (fourth from left section), mean corpuscular volume (MCV) in femtoliters (third from the right section); mean corpuscular hemoglobin (MCH) in picograms (second from the right section) and mean corpuscular hemoglobin concentration (MCHC in g/dL (right-most section) before filtration (solid black bars), after filtration (white bars), after combination with the APEX solution described herein (diagonally striped rising to the left bars) before filtration (solid black bars) and after leukoreduction filtration (solid white bars) on the day of the whole blood collection, as well as the indicated metrics on day 1 after collection and filtration (diagonally striped rising to the right bars), day 7 after collection and filtration (horizontal bars), and day 14 after collection and filtration (vertical striped bars). Note: Red cell reductions are due to removal of whole blood product aliquots). On day 14, around 20% of platelets appear in the red blood cell concentrates.

FIG. 4 is a graph showing morphological and functional characteristics of platelets (PLT) derived from whole blood units stored in a solution including a first additive (CPD) and a second additive (APEX™) in accordance with principles of the present invention on day 1 (solid black bars), day 7 (white bars), and day 14 (diagonally striped rising to the left bars after whole blood collection. The graph in FIG. 4 shows morphological and functional characteristics of platelets (PLT) derived from CPD/APEX Whole Blood units (n=5). In FIG. 4, “MPV” is the mean platelet volume; “HSR” is hypotonic shock response; and “ESC” is extent of shape change.

Thus, the various aspects and embodiments of the present invention enable blood transfusion products that facilitate a shift from blood component therapy to whole blood therapy, so as to reduce weight, cube, and complexity of transfusion for forward care providers providing forward damage control resuscitation (FDCR). Blood component therapy is the separation of donated whole blood into its component parts of red blood cells, plasma, and platelets. This allows the RBCs, plasma, and platelets from a single donation to support the red cell needs of a patient with anemia, the plasma needs of a patient undergoing plasma exchange for myasthenia gravis, and the platelets support a child with leukemia undergoing chemotherapy (i.e, blood from a single source or draw can be separated into components an provided to multiple different recipients). However, acutely injured warfighters are bleeding most commonly and need all three of the components to address their needs for blood volume replacement, oxygen-carrying RBCs, and procoagulant plasma and platelets. Getting three separate components back to injured warfighters is difficult now as the storage requirements for the individual blood components have diverged. Today, RBCs are stored in the refrigerator in an extra 100 to 110 mL of additive solution, platelets are stored at room temperature with agitation to facilitate their respiration, and plasma is stored frozen and thawed only as needed. The divergent storage requirements means that large-volume blood support is logistically complicated, requiring many bags of many components, each with their own logistical requirements such as freezers, refrigerators, air conditioning, and agitators. Building simpler blood support tools based on keeping whole blood whole, using simplified blood collection sets, optimized storage solutions and simple ice-chest storage conditions, can eliminate the need for freezers and air conditioning, reduce the weight of collection sets and processed blood products, and reduce blood transport box weight and energy requirements. These actions will enable more blood to be sent forward or collected forward to support more care closer to the sites of injury on increasingly austere battlefields and medical emergencies.

The compositions and systems of the present invention will provide a longer shelf life for whole blood collected. For example, using the present invention, whole blood collected in a primary and/or secondary blood bag may be stored for ≥42 days (see FIG. 1) with superior RBC quality, platelet function, and plasma factor stability over current conventional CPDA-1 blood bags.

Thus, the composition of the present invention accomplishes the objectives of (a) prevention of activation of the clotting cascade; and (b) preservation of quantitative and qualitative levels of whole blood components during long-term, refrigerated storage with or without agitation during the storage.

Turning now to FIG. 5, a schematic showing the system for collection and storage of blood and blood products in accordance with an embodiment of the invention is depicted. In the illustrated embodiment of FIG. 5, a whole blood storage system 10 includes a first receptacle 12 (such as a first blood donor bag). A blood input system 14 may be operatively connected to the first receptacle 12 to allow for blood to be delivered to the first receptacle 12 from a donor. The blood input system 14 may include a collection needle 16, a needle protector 18, and a collection conduit 20, as shown in FIG. 5.

A first additive may be contained within first receptacle 12. The first additive, in some embodiments, has anti-coagulating properties. In certain embodiments of the present invention, the first additive may be CPD, CP2D, CPDA-1, or CPDA-2. And, in certain embodiments, the first additive may be present in a volume of about 1/7 that of the anticipated blood draw (about 63 mL for a conventional “pint” draw of 450 mL or about 70 mL for a modern 500 mL draw). Thus, in certain embodiments, the first receptacle 12 may include 63 mL or 70 mL of the first additive (e.g., CPD, CPDA-1, or CPDA-2) for collection of 450 mL or 500 mL of whole blood, respectively.

The whole blood storage system 10, as in the embodiment illustrated in FIG. 5, may also include a second receptacle 22, having a second additive contained therein. In certain embodiments, the second additive may be an APEX additive. Thus, the second additive may include sodium bicarbonate (NaHCO₃), mannitol (C₆H₁₄O₆), sodium acetate (C₂H₃NaO₂), and magnesium citrate (C₆H₆MgO₇). In additional embodiments, that composition may also include sodium bisphosphate (Na₂HPO₄), guanosine (C₁₀H₁₃N₅O₅), or carnitine (C₇H₁₅NO₃) or any combination of these ingredients.

In still further embodiments, adenine (C₅H₅N₅) may be added to the composition. For example, as described above, the first receptacle 12 may include a first additive such as CPD, CP2D, CPDA-1, or CPDA-2. It will be recognized by those of ordinary skill in the art that CPDA-1 and CPDA-2 each include adenine as part of the formulation, while CPD does not include adenine. Thus, in embodiments where CPD is used as the first additive, one may choose to use a second additive that includes adenine (i.e., an APEX formulation including adenine) in the second receptacle 22.

Thus, in one specific embodiment where the first additive in the first receptacle is CPD (e.g., at 63 mL or 70 mL, as described above), the second receptacle 22 may include 50 mL of a second additive including 80 mM sodium bicarbonate, 110 mM mannitol, 100 mM sodium acetate, 8 mM magnesium citrate, and 4 mM adenine. In another specific embodiment where the first additive in the first receptacle is CPDA-1 (e.g., at 63 mL or 70 mL, as described above), the second receptacle 22 may include 50 ml of a second additive including 80 mM sodium bicarbonate, 110 mM mannitol, 100 mM sodium acetate, and 8 mM magnesium citrate.

In other embodiments, the second additive may or may not have anti-coagulating properties on its own. But in certain embodiments, the combination of the first and second additives has anti-coagulative properties and superior storage capability for blood as compared to the use of the first additive alone.

The second additive may be added to the first additive prior to or after whole blood is collected in first receptacle 12. A purpose of the first and second additives is to improve storage capability of the collected (and to be processed) whole blood. The volume and anticoagulant content may be selected to provide optimum nutrients for storage of blood, a means of prevention of degradation products from sterilization of blood bag set by steam sterilization, and to reduce cost of the set by eliminating bypass or soft filter requirements to maximize post filter blood recovery and minimizing excess air present in blood or blood components for storage.

To facilitate combination of the first and second additives, the first receptacle 12 may be in fluid communication with the second receptacle 22 via a line 24 that provides a fluid path between first receptacle 12 and second receptacle 22. As can be seen in the illustrated embodiment of FIG. 5, first receptacle includes an outlet port 26 and second receptacle 22 includes an inlet port 28, with line 24 extending therebetween. The second receptacle 22, as shown in FIG. 5, also includes two outlet ports 30, 32.

Additionally, as shown in the illustrated embodiment of FIG. 5, a filter 34 (e.g., a leukoreduction filter) may be present in the line 24 between the first receptacle 12 and the second receptacle 22. Various leukoreduction filters may be used, having various characteristics. For example, filter 34 may exhibit a particular dwell—such as a 40 mL dwell. Standard leukoreduction filters capture platelets, but there are currently platelet sparing filters available such as those used in IMUFLEX WB-SP bloodstorage system by Terumo (code: 1 BB*LGQ506A6) which would be suitable for use in embodiments of the system according to principles of the present invention.

It will also be noted that, when filter 34 is present in the fluid path between first receptacle 12 and second receptacle 22, line 24 need not be a continuous line, but rather may have a distinct first line segment 24a (which allows transport of fluid—blood—from first receptacle 12 to filter 34), and a distinct second line segment 24b (which allows transport of fluid—blood—from filter 34 to second receptacle 22). Those of skill in the art will also recognize that direction of travel may be reversed, such that fluid (e.g., blood) can be allowed to move from second receptacle 22 to first receptacle 12.

In one embodiment, the first receptacle 12 can be connected to the second receptacle by line 24 (e.g., tubing) with an integral whole blood leukocyte reduction filter that is long enough to be heat sealed into about 8-12 segments about 2-4 inches long for blood typing and sampling. In alternate embodiments, the second receptacle 22 can contain at least about 40 mL of sodium bicarbonate solution at about 12 mEq strength in sterile water for injection.

At least one and, in certain embodiments, both of the first receptacle 12 and the second receptacle 22 are suitable for the storage of whole blood and/or blood plasma and/or red blood cells (RBC). In further embodiments of the present invention, whole blood that that is collected by the system of the present invention can be stored for at least about 2 weeks or at least about 3 weeks or at least about 4 weeks or at least about 5 weeks, and can subsequently be further processed into red blood cells (RBCs) and plasma, and at least the RBCs can be stored for further periods and at least about 2 weeks or at least about 3 weeks or at least about 4 weeks or at least about 5 weeks or at least about 6 weeks from whole blood collection.

Due to the ability of the composition and storage system of the present invention to extend the shelf life preservation of whole blood and blood components, the composition may also be suited for use in non-DEHP blood containers. As is known to those of ordinary skill in the art the plasticizer DEHP is used in blood bags to enhance their pliability and is known to assist in RBC storage; however, the DEHP is also known to leach out of the bags and be taken up by RBCs. With the use of the present composition to extend storage life, one can obtain the benefits of extended life in a container that does not need to use DEHP.

In one specific non-limiting embodiment, the system design of the present invention is based on a 16G needle connection to a primary collection, conventional, 600 mL plastic bag (i.e., a first receptacle) made of, for example, a polyvinyl cellulose (PVC)/di-(2-ethyl hydroxy-phthalate) (DEHP) in a closed system. In some embodiments, the plastic bag is a volume other than 600 mL In some embodiments, the primary bag is FDA approved. In some embodiments, the primary bag is made of a plastic other than PVC. In some embodiments, the primary bag comprises a non-phthalate plasticizer. In some embodiments, this primary bag is connected to leukoreduction filter, such as the FDA-licensed, platelet sparing leukoreduction filter available from Terumo, Lakewood, CO) with 40 mL dwell (i.e., a hold-up volume of 40 mL) and a secondary bag or vessel (i.e., a second receptacle) with two output ports and 50 mL of the novel storage solution of the present invention. In some embodiments, the secondary bag is FDA approved. In some embodiments, the secondary bag is made of a plastic other than PVC. In some embodiments, the secondary bag comprises a non-phthalate plasticizer.

In some embodiments, the primary bag contains 70 mL of citrate/phosphate/dextrose (CPDA-1, USP) where mM concentrations of the formulation are provided in Table 1. Blood can be collected at a ratio of 1.4:10 in the standard anticoagulant CPDA-1 or CPD. Blood can also be collected at other ratios into other standard anticoagulants as is well known in the field of blood collection.

TABLE 1
Composition CPDA-1, APEX-1A, CPDA-1/APEX-1A
and SOLX ® (AS-7)

| | | | CPDA-1 + | |
|---|---|---|---|---|
| | CPDA-1 | APEX-1A | APEX-1A | SOLX |
| Ingredients | (mM) | (mM) | (mM) | (mM) |
| NaHCO3 | 0 | 80 | 33.3 | 26 |
| Citric Acid | 15.6 | | 9.1 | |
| NaH2PO4 | 16.1 | | 9.4 | |
| Na2HPO4 | | 24 | 10.0 | 12 |
| Adenine | 2 | 0 | 1.2 | 2 |
| Glucose | 161 | | 75.1 | 93.9 |
| Mannitol | 0 | 110 | 45.8 | 55 |
| Na3citrate | 89.4 | | 52.2 | |
| Na acetate | 0 | 100 | 41.7 | |
| Mg citrate | 0 | 8 | 3.3 | |
| Volume (mL) | 70 | 50 | 120 | 110 |

In some embodiments of the invention, whole blood will be collected in the primary bag, mixed with standard anticoagulant(s) (e.g., CPDA-1), and maintained at room temperature until filtration. In a non-limiting embodiment, anticoagulated whole blood in the primary bag will be passed through to a platelet sparing leukoreduced filter within about 8 hours of collection (although filtration can occur after 8 hours of collection as well) and into the secondary bag for storage and further processing. Filtration will be performed according to manufacturer's instructions and testing will be conducted on stored whole blood weekly during the storage period of at least 14 days, or at least 21 days or at least 35 days, or at least 42 days, or at least 49 days, at least 56 days.

In one embodiment, the APEX whole blood collection system utilizes two solutions for preservation of whole blood. The first solution is standard CPDA-1 anticoagulant, and it is complemented with APEX-1A formulation in a 50 mL format that contains 80 mM sodium bicarbonate (NaHCO₃), 24 mM sodium bisphosphate (Na₂HPO₄), 110 mM mannitol, 100 mM sodium acetate and 8 mM magnesium citrate (Table 1). Final osmolality is close to iso-osmolar. All these components are known chemicals that are chemically stable and physiologically active. The formulation has been designed to maintain the metabolic needs of red cells and platelets with potential storage shelf-life of up to 42 days.

Note the present invention is not meant to be limited by non-limiting APEX-1A formulation. Other formulations containing other components are contemplated herein. The following Table 2 provides ranges of components that can be used in a formulation of the invention along with pH ranges.

TABLE 2

| | Concentration range in |
|---|---|
| | about 50 mL of secondary |
| Ingredient | additive (mM) |
| Bicarbonate salt | 40-120 |
| Phosphate salt | 10-30 |
| Mannitol | 55-165 |
| Acetate salts | 50-150 |
| Magnesium Salts | 0 to 10 |
| Adenine | 0 to 4 |
| pH | 7-10 |

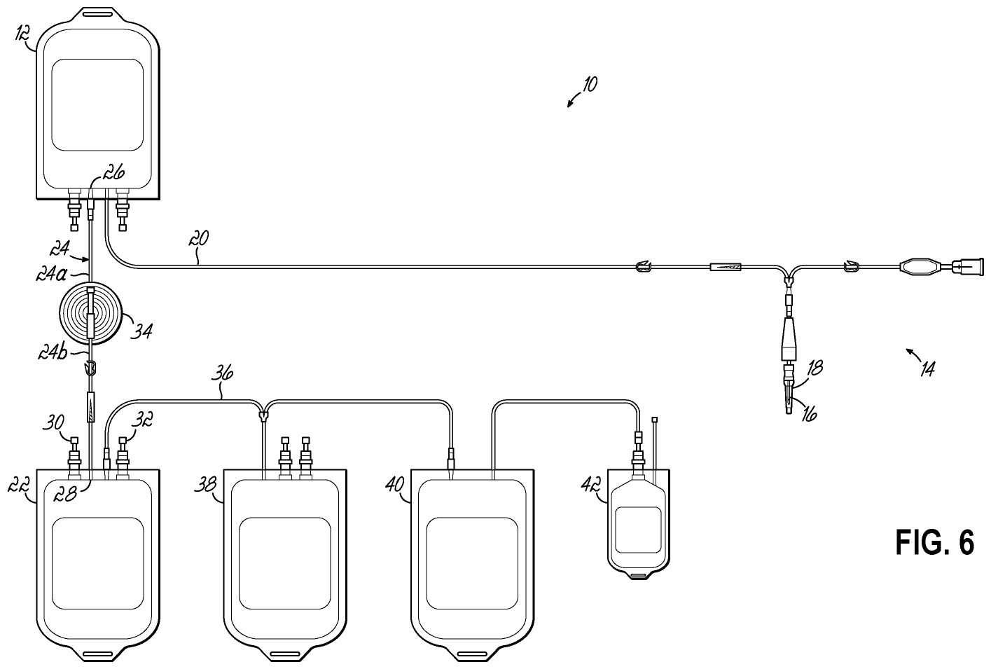

Further, and with reference to FIG. 6, an additional line or lines 36 may be provided from the second receptacle 22, to facilitate transfer and preparation of blood components after separation of whole blood into blood components (typically a centrifuge, although other means for separating RBCs from plasma could be used in accordance with embodiments of the present invention). Separate plasma may proceed through line 36 into a plasma bag 38 and separated RBCs through proceed through a line into bag 40, or RBC additive solution(s) contained in additional bag 40 may be transferred into the second receptacle 22 for storage of red blood cells in additive solution (FIG. 6 can show an embodiment where RBCs may be present in second receptacle 22). While a centrifuge is discussed herein, other means for separating the components of whole blood can be used in accordance with the present invention without affecting the scope of the present invention.

In accordance with additional embodiments of the present invention, a further additive could be stored in a bag or bags to be combined with separate RBCs from Whole Blood. Although RBCs may be transferred to a bag, in an embodiment such as in FIG. 6, one could maintain RBCs in the second receptacle 22 after whole blood separation and transfer of plasma to a plasma bag 38. Additionally, a further additive such as Red Blood Cell additive AS-7 (SOLX®) could be stored in an additional additive bag (not shown) or bags 40 and/or 42 for transfer through a line into second receptable 22 alone or into another bag (not shown) for use.

It is also possible to make a similar system in which citric acid, sodium citrate, and dextrose are the primary anticoagulant in the first receptacle 12 and phosphate, bicarbonate and adenine are in the second receptacle 22 with relatively less volume in the first receptacle and more of the volume in the second receptacle.

In one embodiment, in use, venous blood typically from the arm of the donor drains into the anticoagulant in the first receptacle 12 (as in standard blood collection) and is mixed during collection by gentle agitation. If a platelet product is of interest, the whole blood is held and processed at room temperature. Otherwise, whole blood may be stored in refrigerated storage (typically 1-6° C.) until used or processed into components. In certain embodiments, a preference may be to hold blood at room temperature prior to processing into components as better platelet yields may be possible. In some embodiments, regardless of which blood component is being stored, the whole blood or components thereof including RBCs and platelets are gently agitated throughout the storage period (e.g., at least about 2 weeks or at least about 3 weeks or at least about 4 weeks or at least about 5 weeks or at least about 6 weeks or at least about 7 weeks) according to standard methods. In some embodiments, regardless of which blood component is being stored, the whole blood or components thereof including RBCs and platelets are not agitated throughout the storage period (e.g., at least about 2 weeks or at least about 3 weeks or at least about 4 weeks or at least about 5 weeks or at least about 6 weeks or at least about 7 weeks.

Processing may include running about 40 mL of second additive in the second receptacle 22 through the filter 34 to thoroughly wet the filter 34 by hanging the system with the second receptacle 22 on top. When substantially all of the solution is in or through the filter 34 the system may be inverted and the whole blood is drained from the first receptacle 12 through the filter 34 into the second receptacle 22, and the second receptacle 22 is mixed, line 24 filled with whole blood, segmented by heat sealing, and the second receptacle 22 may then be placed in refrigeration.

The first and second additives are preferably stored separately prior to use or may be mixed after sterilization of the blood collection set.

In various embodiments, the volume of fluid in the second receptacle 22 may be varied from about 15 to 60 mL to insure adequate wetting of the filter 34. The expected volume of second additive in the second receptacle 22 should be at least the holdup volume of the filter 34. The concentration of second additive in the second receptacle 22 may be varied from about 5 to 60 mEq—in certain embodiments—which can help to ensure that the starting pH of blood storage is approximately 7.2 so that ATP metabolism in not disturbed. In certain embodiments, a concentration of about 12 mEq may be used. (See Hess J R, Hill H R, Oliver C K, Lippert L E, Greenwalt T J. Alkaline CPD and the preservation of RBC2,3-DPG, Transfusion. 2002 June; 42(6):747-752.)

Therefore, in one embodiment of the present invention, a whole blood storage system that includes whole blood leukoreduction filter with pH optimization for improved red blood cell (RBC) storage, comprises a first additive and a second additive, wherein, upon the first additive and the second additive being combined with whole blood, the coagulation capability of the whole blood is maintained for at least about 2 weeks or at least about 3 weeks or at least about 4 weeks.

In another embodiment at least the first additive comprises an anti-coagulating agent (and in certain embodiments may comprise at least one of citric acid, sodium citrate, and dextrose). In some embodiments, upon the first additive and the second additive being combined with whole blood, the whole blood can be preserved for at least about 2 weeks, or at least about 3 weeks, or at least about 4 weeks, or at least about 5 weeks after the combination of the whole blood with the first and second additive, and red blood cells can be preserved for for about 2 weeks, or at least about 3 weeks, or at least about 4 weeks, or at least about 5 weeks, or at least about 6 weeks.

Whole blood stored in this system for 2 to 5 weeks can then be processed into RBCs in separate additive solution(s) for preservation of red blood cells in additive solutions for at least 6 from whole blood collection (or phlebotomy).

In a method of storing whole blood in such manner (and in accordance with the present invention), a whole blood storage system that includes whole blood leukoreduction with pH optimization for improved red blood cell (RBC) storage, the storage system comprising a first additive bag containing a first additive and a second additive bag containing a second additive. The method includes the steps of adding whole blood to be processed into the first additive bag, and before or after adding the whole blood to be processed into the first additive bag, transferring the second additive from the second additive bag to the first additive bag. The whole blood combined and mixed with the two additives may be leukoreduced by passing the whole blood mixture (with the two additives) through the leukoreduction filter (preferably platelet sparing) to produce leukoreduced whole blood. Leukoreduced whole blood may be stored for transfusion or processed into blood components by methods in the prior art.

The additives combine to preserve the RBCs and maintain or mostly maintain the coagulation capability of the whole blood for at least about 2 weeks or at least about 3 weeks or at least about 4 weeks, and then the whole blood and/or the RBCs can be stored for a period of up to about 2 weeks, or up to about 3 weeks, or up to about 4 weeks, or up to about 5 weeks, or up to about 6 weeks or at least about 7 weeks or at least about 8 weeks after collection or phlebotomy. In some embodiments, at least one leukoreduction filter is included in the system, which leukoreduction filter may be platelet sparing. The first additive comprises an anti-coagulating agent. Subsequent to the storing of the whole blood, RBCs can be separated from the whole blood resulting in RBCs and plasma, which can be stored for additional time.

This invention is designed to optimize whole blood collection for use in blood centers supporting field medical operations or processed into blood components for component therapy. Additionally, it could be used in the field in support of walking blood banks in remote locations such as distant military theaters or remote island territories.

The embodiments of the present invention recited herein are intended to be merely exemplary and those skilled in the art will be able to make numerous variations and modifications to it without departing from the spirit of the present invention. Notwithstanding the above, certain variations and modifications, while producing less than optimal results, may still produce satisfactory results. All such variations and modifications are intended to be within the scope of the present invention as defined by the claims appended hereto.

What is claimed:

1. A whole blood anticoagulant composition comprising one or more sodium salts, one or more magnesium salts, and one or more sugar alcohols.

2. The composition of claim 1, wherein the one or more sodium salts include sodium bicarbonate and sodium acetate, the one or more magnesium salts include magnesium citrate, and the one or more sugar alcohols include mannitol.

3. The composition of claim 2, further comprising sodium bisphosphate.

4. The composition of any of claims 1-3, further comprising at least one nucleobase-containing component.

5. The composition of claim 4, wherein the at least one nucleobase-containing component comprises adenine.

6. The composition of claim 1, further comprising one or more sugars.

7. The composition of claim 6, wherein the one or more sugars are selected from the group consisting of dextrose and glucose.

8. The composition of claim 2, wherein the molar concentrations of sodium bicarbonate, mannitol, sodium acetate, and magnesium citrate in the composition are 40-120 mM sodium bicarbonate, 55-165 mM mannitol, 50-150 mM sodium acetate, and 0.5-10 mM magnesium citrate.

9. The composition of claim 8, wherein the molar concentrations of sodium bicarbonate, mannitol, sodium acetate, and magnesium citrate in the composition are 80 mM sodium bicarbonate, 110 mM mannitol, 100 mM sodium acetate, and 8 mM magnesium citrate.

10. The composition of claim 2, wherein the molar concentrations of sodium bicarbonate, sodium bisphosphate, mannitol, sodium acetate, and magnesium citrate in the composition are 40-120 mM sodium bicarbonate, 10-30 mM sodium bisphosphate, 55-165 mM mannitol, 50-150 mM sodium acetate, and 0.5-10 mM magnesium citrate.

11. The composition of claim 10, wherein the molar concentrations of sodium bicarbonate, sodium bisphosphate, mannitol, sodium acetate, and magnesium citrate in the composition are 80 mM sodium bicarbonate, 24 mM sodium bisphosphate, 110 mM mannitol, 100 mM sodium acetate, and 8 mM magnesium citrate.

12. A whole blood anticoagulant composition comprising a first substance and a second substance, wherein the first substance includes a plurality of components, the plurality of components comprising one or more sodium salts, one or more magnesium salts, and one or more sugar alcohols.

13. The composition of claim 12, wherein the one or more sodium salts include sodium bicarbonate and sodium acetate, the one or more magnesium salts include magnesium citrate, and the one or more sugar alcohols include mannitol.

14. The composition of claim 13, the plurality of components further comprising sodium bisphosphate.

15. The composition of claim 14, wherein the second substance includes a plurality of components, the plurality of components comprising citric acid, sodium bisphosphate, adenine, glucose and sodium citrate.

16. The composition of claim 15, wherein the molar concentrations of the components of the first substance and the second substance in the composition are, 40-120 mM sodium bicarbonate, 10-30 mM sodium bisphosphate, 30-65 mM mannitol, 30-65 mM sodium acetate, and 5-15 mM magnesium citrate, 5-15 mM citric acid, 0.25-5 mM adenine, 50-100 mM glucose, and 30-65 mM sodium citrate.

17. The composition of claim 15, wherein the molar concentrations of the components of the first substance and the second substance in the composition are 33.3 mM sodium bicarbonate, 19.4 mM sodium bisphosphate, 45.8 mM mannitol, 41.7 mM sodium acetate, 8 mM magnesium citrate, 9.1 mM citric acid, 1.2 mM adenine, 75.1 mM glucose, and 52.2 mM sodium citrate.

18. A whole blood storage system, comprising:
a first additive comprising one or more sodium salts, one or more magnesium salts, and one or more sugar alcohols; and
a second additive;
wherein upon the first additive and the second additive being combined with whole blood the coagulation capability of the whole blood is maintained or mostly maintained for at least about 2 weeks or at least about 3 weeks.

19. The whole blood storage system of claim 18, wherein the one or more sodium salts include sodium bicarbonate, sodium acetate, and sodium bisphosphate, the one or more magnesium salts include magnesium citrate, and the one or more sugar alcohols include mannitol.

20. The whole blood storage system of claim 18, wherein the second additive comprises an anti-coagulating agent.

21. A whole blood storage system, comprising:
a first additive comprising one or more sodium salts, one or more magnesium salts, and one or more sugar alcohols; and
a second additive;
wherein upon the first additive and the second additive being combined with whole blood, the whole blood can be preserved for at least about weeks or at least about 3 weeks or at least about 4 weeks or at least about 5 weeks and red blood cells for at least about weeks or at least about 3 weeks or at least about 4 weeks or at least about 5 weeks or at least about 6 weeks.

22. The whole blood storage system of claim 21, wherein the one or more sodium salts include sodium bicarbonate, sodium acetate, and sodium bisphosphate, the one or more magnesium salts include magnesium citrate, and the one or more sugar alcohols include mannitol.

23. The whole blood storage system of claim 21, wherein the second additive comprises at least one of citric acid, sodium citrate, and dextrose.

24. The whole blood storage system of claim 21, wherein the second additive comprises CPDA-1 or CPDA-2.

25. The whole blood storage system of claim 21, wherein the first and second additives are stored separately prior to use.

26. The whole blood storage system of claim 25, wherein the first additive is stored in a first receptacle, and the second additive is stored in a second receptacle, wherein at least one of the first and second receptacles is suitable for whole blood storage.

27. The whole blood storage system of claim 26, wherein the first receptacle and the second receptacle are in fluid communication with one another via a fluid path, and wherein the system further comprises at least one leukoreduction filter in the fluid path.

28. The whole blood storage system of claim 26, wherein the at least one of the first and second receptacles that is suitable for whole blood storage is configured to receive the other of said first and second additives and whole blood whereupon said whole blood can be preserved for at least about 2 weeks or at least about 3 weeks or at least about 4 weeks or at least about 5 weeks.

29. The whole blood storage system of claim 21, wherein whole blood stored in this system for at least about 2 weeks or at least about 3 weeks or at least about 4 weeks or at least about 5 weeks can then be processed into RBCs in separate additive solution for preservation of at least about 2 weeks or at least about 3 weeks or at least about 4 weeks or at least about 5 weeks or at least about 6 weeks.

30. The whole blood storage system of claim 27, wherein the leukoreduction filter is a platelet sparing leukoreduction filter.

31. The whole blood storage system of claim 21, further comprising: a centrifuge for separating RBCs and plasma from whole blood; and
a RBC storage receptacle connected to said centrifuge to receive RBCs separated from the whole blood; and a plasma storage receptacle connected to said centrifuge to receive plasma separated from the whole blood.

32. A method of storing whole blood, comprising:
adding whole blood to be collected into a first receptacle, the first receptacle containing a first additive;
transferring a second additive comprising one or more sodium salts, one or more magnesium salts, and one or more sugar alcohols from a second receptacle to the first receptacle;
wherein the transferring step occurs before or after the step of adding whole blood into the first receptacle.

33. The method of claim 32, wherein the one or more sodium salts include sodium bicarbonate, sodium acetate, and sodium bisphosphate, the one or more magnesium salts include magnesium citrate, and the one or more sugar alcohols include mannitol.

34. The method of claim 32, wherein the first additive and second additive combine to preserve any RBCs and maintain or mostly maintain coagulation capability of the whole blood for at least about 2 weeks or at least about 3 weeks.

35. The method of claim 34, further comprising storing the whole blood for a period of at least about 2 weeks or at least about 3 weeks or at least about 4 weeks or at least about 5 weeks.

36. The method of claim 34, further comprising separating RBCs from the whole blood.

37. The method of claim 36, further comprising storing the RBCs for a period of at least about 2 weeks or at least about 3 weeks or at least about 4 weeks or at least about 5 weeks or at least about 6 weeks.

38. The method of claim 32, further comprising passing the whole blood through at least one leukoreduction filter.

39. The method of claim 38, wherein the leukoreduction filter is a platelet sparing leukoreduction filter.

40. The method of claim 35, further comprising separating RBCs from the whole blood resulting in RBCs and plasma subsequent to the storing of the whole blood for a period of at least about 2 weeks or at least about 3 weeks or at least about 4 weeks or at least about 5 weeks or at least about 6 weeks or at least about 7 weeks.
